(19) United States
(12) Patent Application Publication
(10) Pub. No.: US 2015/0115605 A1
(43) Pub. Date: Apr. 30, 2015

(54) LOCK BAND AND METHOD OF MANUFACTURING

(71) Applicant: Hart & Cooley, Inc., Grand Rapids, MI (US)

(72) Inventors: Daniel J. Gramza, Rockford, MI (US); Eric W. Palmbos, Allendale, MI (US); Michael R. Lutz, Allendale, MI (US); Keith E. Page, Zeeland, MI (US); Clark E. Pridemore, Grand Rapids, MI (US)

(73) Assignee: Hart & Cooley, Inc., Grand Rapids, MI (US)

(21) Appl. No.: 14/065,307

(22) Filed: Oct. 28, 2013

(51) Int. Cl. F16L 23/08

(52) U.S. Cl. CPC F16L 23/08
USPC 285/410

(57) ABSTRACT

A device comprising an adjustable band configured to be installed around a pipe and a locking assembly disposed on the adjustable band.

### TECHNICAL FIELD

The present disclosure relates to pipe fittings, and more specifically to a lock band that can be used to secure two pipes together.

### BACKGROUND OF THE INVENTION

Piping can include male and female fittings, where the male fitting can be inserted into the female fitting in order to form a joint.

### SUMMARY OF THE INVENTION

A device comprising a band configured to be installed around a pipe is disclosed, with a locking assembly disposed on the band that locks to a pipe joint assembly.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a dual lock band in accordance with an exemplary embodiment of the present disclosure;

FIG. 2 is a diagram of a unitary lock band with a hooked attachment in accordance with an exemplary embodiment of the present disclosure;

FIG. 3 is a diagram of a unitary lock band with a lanced clip in accordance with an exemplary embodiment of the present disclosure;

FIG. 4 is a diagram of a dual lock band installed on a pipe fitting in accordance with an exemplary embodiment of the present disclosure;

FIG. 5 is a diagram of a unitary lock band with a hooked attachment installed on a pipe fitting in accordance with an exemplary embodiment of the present disclosure; and

FIG. 6 is a diagram of a unitary lock band with a lanced clip installed on a pipe fitting in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

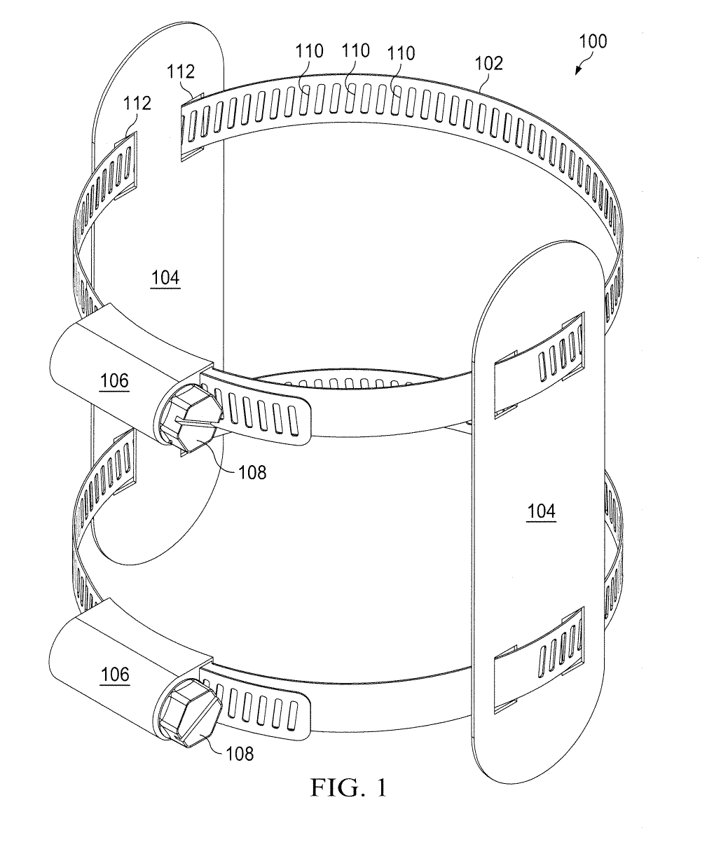

FIG. 1 is a diagram of a dual lock band 100 in accordance with an exemplary embodiment of the present disclosure. Dual lock band 100 can be made from metal, plastic or other suitable materials.

Dual lock band 100 includes adjustable bands 102, which are configured to be placed on adjacent pipe segments that have been mated to form a joint. Adjustable bands 102 are fed through lock band straps 104, which hold the adjustable bands 102 in a predetermined relationship, so as to secure the adjacent pipe segments. In one exemplary embodiment, a pipe segment with a female pipe fitting will include a flare that increases the outer diameter of the pipe end, and the male pipe fitting can be placed inside of the female pipe fitting to form a joint. Dual lock band 100 can be installed on the male and female pipe ends after the joint is formed, and prevents the male and female pipe segments from separation. Although adjustable bands are shown and described both here and throughout the application, a band that is not adjustable can also or alternatively be used, where suitable.

Dual lock band 100 can be manufactured from metal bands, which are machined to form a number of slots 110 along the length of the metal band. A lock assembly 106 can be secured to one end of the metal band, and can include a slot for receiving the other end of the metal band. A locking mechanism (not explicitly shown) within lock assembly 106 is then inserted into one or more of slots 110, and screw 108 the lock mechanism to secure lock assembly 106 to the metal band. Prior to inserting the metal band into lock assembly 106, the metal band is inserted through lock band straps 104. In one exemplary embodiment, a hose clamp assembly can be used for adjustable bands 102. Lock band straps 104 can be made from plastic or metal, although a durable and flexible plastic can be used to improve the ease of assembly without detracting from the reliability of dual lock band 100. Each lock band strap 104 includes four slots 112, with two slots disposed on either end and configured to allow adjustable band 102 to be threaded through each slot as shown, so as to secure lock band strap 104 to each adjustable band 102. Although two slots are shown, a single slot or other suitable numbers of slots can also or alternatively be used.

In operation, dual lock band 100 provides a mechanism for securely and reliably ensuring that two pipes at a pipe joint will remain jointed. Dual lock band 100 can be readily manufactured and assembled on site prior to forming a pipe joint.

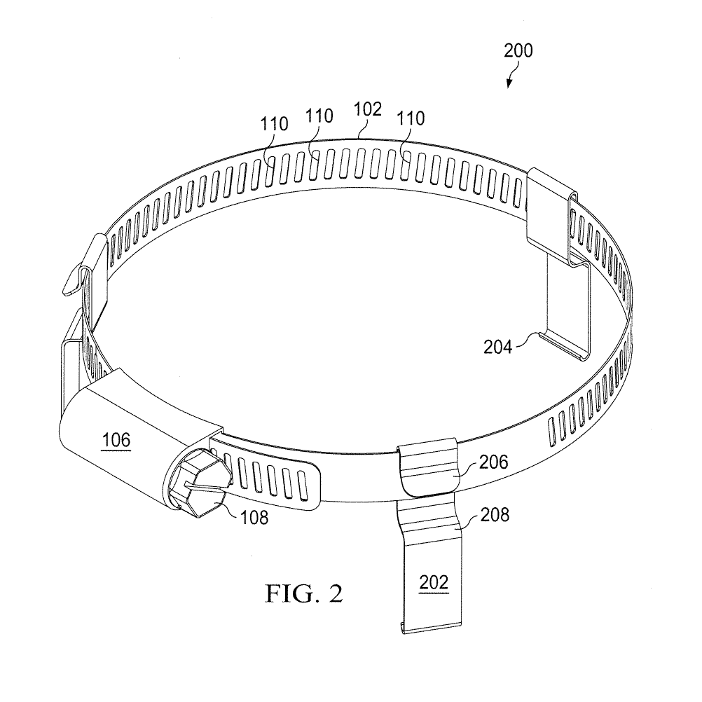

FIG. 2 is a diagram of a unitary lock band 200 with a hooked attachment in accordance with an exemplary embodiment of the present disclosure. Unitary lock band 200 includes three attachments 202, which each include clip 206 that secures attachment 202 to adjustable band 102, and hook 204 that hooks to an edge of the female pipe fitting, such as a gasket bead or other suitable edges. Attachment 202 includes a bend 208 that is provided to allow attachment 200 to clip over the female pipe fitting. In this exemplary embodiment, unitary lock band 200 can be placed on the male pipe fitting before or after the pipe joint is formed. Although unitary lock band 200 is shown with adjustable band 102, lock assembly 106 and screw 108, unitary lock band 200 can alternatively be a solid band that fits over the end of the male pipe fitting prior to forming the joint, such as a metal band, a plastic band, a composite band, a fiberglass band or a band formed of other suitable materials, and attachment 202 can be fitted onto unitary lock band 200 prior to assembly on the pipe fitting. Likewise, unitary lock band 200 can be manufactured in place on a pipe fitting where suitable, or other suitable configurations can also or alternatively be implemented.

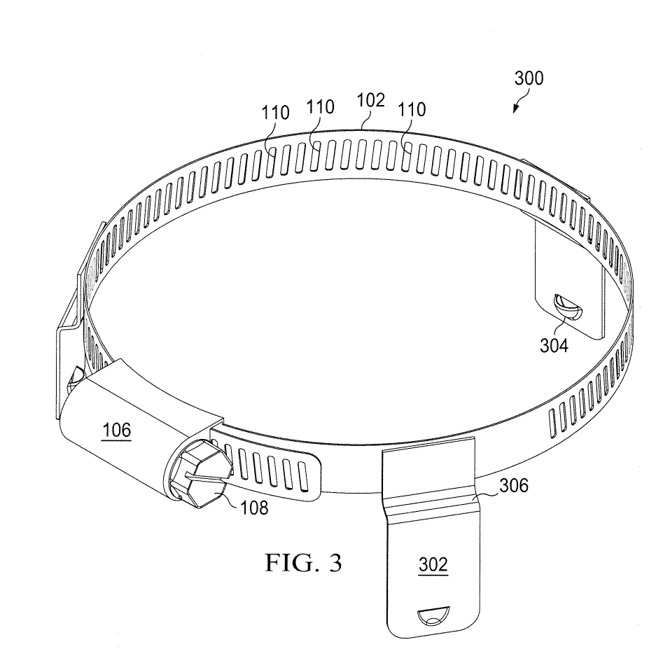

FIG. 3 is a diagram of a unitary lock band 300 with a lanced clip in accordance with an exemplary embodiment of the present disclosure. Unitary lock band 300 includes three attachments 302, which can each be welded or otherwise secured to adjustable band 102. Lance 304 is formed in attachment 302, such as by lancing, punching or my otherwise causing part of attachment 302 to extend outwards from bent portion 306. In this exemplary embodiment, unitary lock band 300 can be placed on the male pipe fitting before or after the pipe joint is formed. Although unitary lock band 300 is shown with adjustable band 102, lock assembly 106 and screw 108, unitary lock band 300 can alternatively be a solid band that fits over the end of the male pipe fitting prior to forming the joint, such as a metal band, a plastic band, a composite band, a fiberglass band or a band formed of other suitable materials, and attachment 302 can be welded onto unitary lock band 300 prior to assembly on the pipe fitting. Likewise, unitary lock band 300 can be manufactured in place on a pipe fitting where suitable, or other suitable configurations can also or alternatively be implemented.

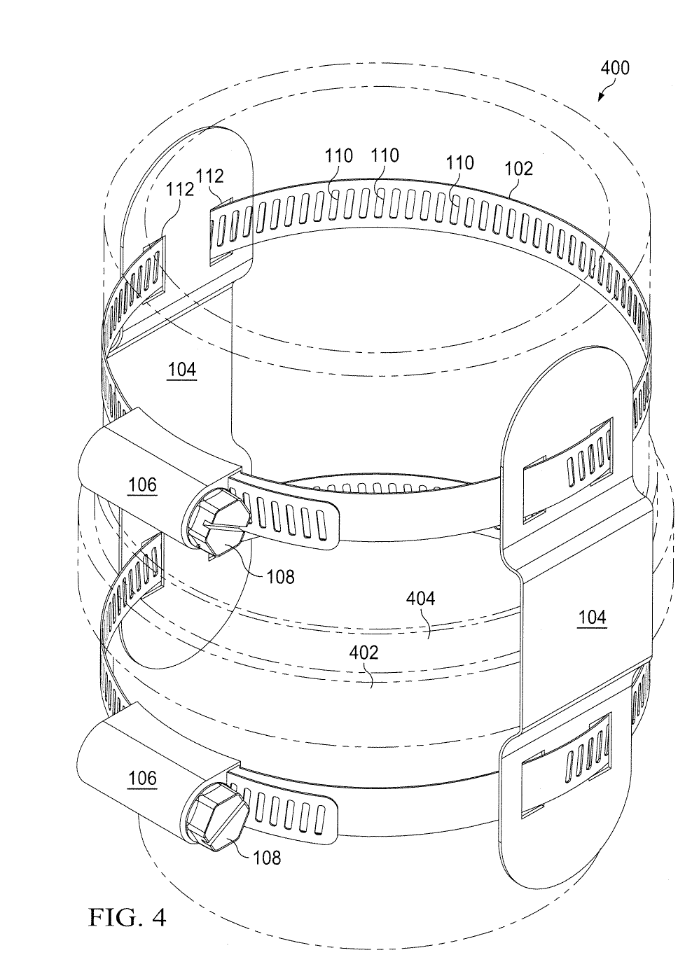

FIG. 4 is a diagram of a dual lock band 100 installed on a pipe fitting 400 in accordance with an exemplary embodiment of the present disclosure. As shown in FIG. 4, adjustable bands 102 of dual lock band 100 are disposed on either side of the joint formed by female pipe fitting 402 and male pipe fitting 404 (shown transparent). In this manner, female pipe fitting 402 and male pipe fitting 404 cannot separate as long as dual lock band 100 remains in place and operational. Adjustable bands 102 can be installed on female pipe fitting 402 and male pipe fitting 404 after the joint is formed.

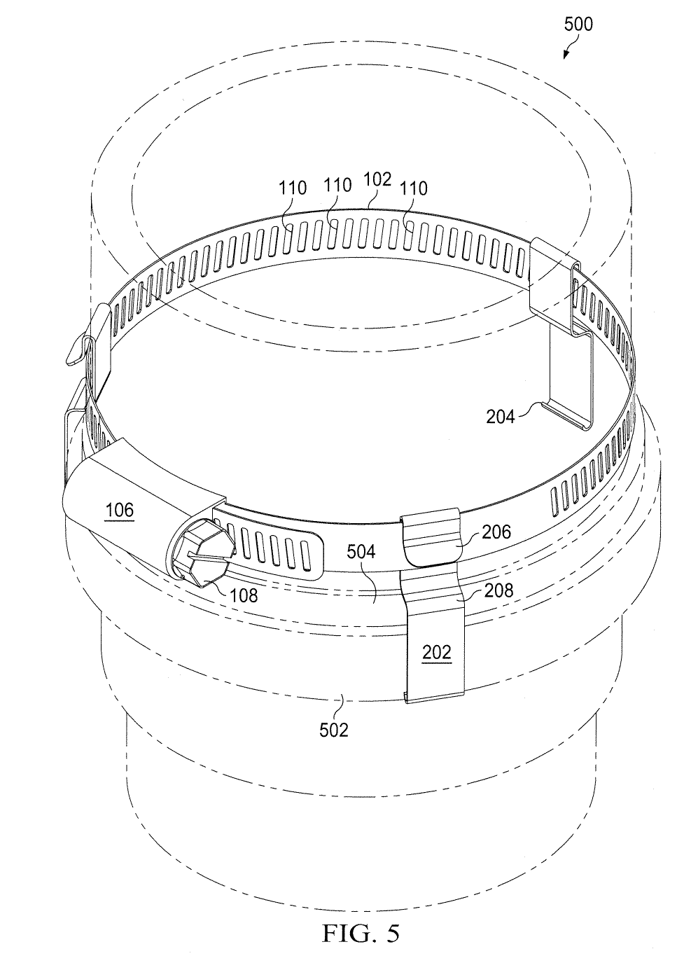

FIG. 5 is a diagram of a unitary lock band 200 with a hooked attachment installed on a pipe fitting 500 in accordance with an exemplary embodiment of the present disclosure. As shown in FIG. 5, adjustable band 102 of unitary lock band 200 is disposed on the male pipe fitting of the joint formed by female pipe fitting 502 and male pipe fitting 504 (shown transparent), and hook 204 is placed over female pipe fitting 502. Bend 206 is used to ensure that attachment 202 can fit over female pipe fitting 502. In this manner, female pipe fitting 502 and male pipe fitting 504 cannot separate as long as unitary lock band 200 remains in place and operational. Adjustable band 102 can be installed on male pipe fitting 504 after the joint is formed. Alternatively, a non-adjustable band can be installed on male pipe fitting 504 before the joint is formed, and attachment 202 can be clipped on the non-adjustable band before or after the joint is formed.

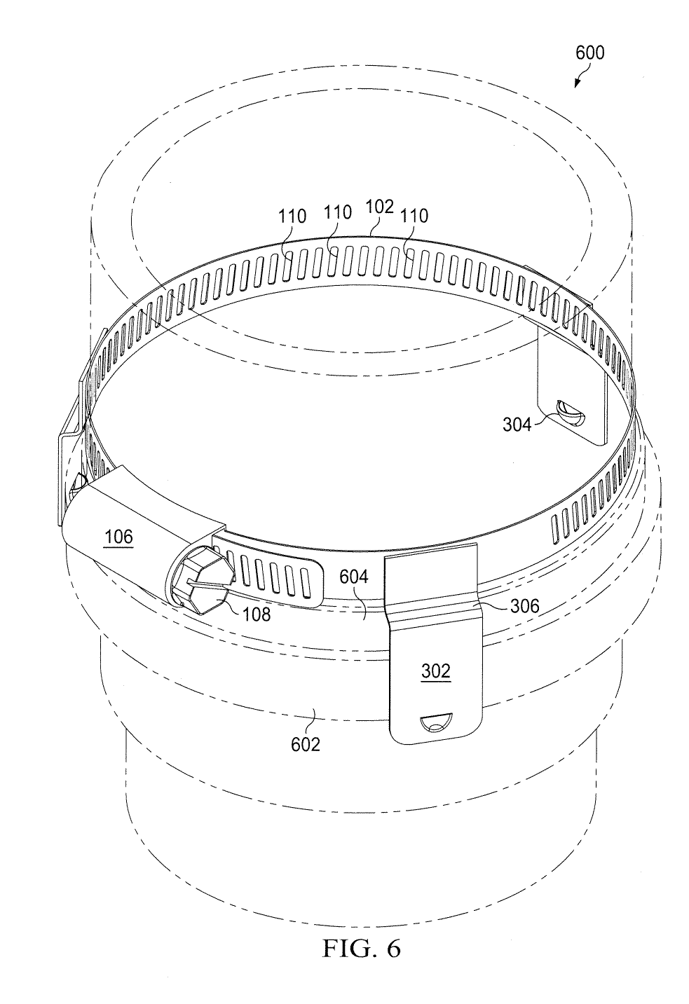

FIG. 6 is a diagram of a unitary lock band 300 with a lanced clip installed on a pipe fitting 600 in accordance with an exemplary embodiment of the present disclosure. As shown in FIG. 5, adjustable band 102 of unitary lock band 300 is disposed on the male pipe fitting of the joint formed by female pipe fitting 602 and male pipe fitting 604 (shown transparent), and protrusion 304 is placed over female pipe fitting 602. Bend 306 is used to ensure that attachment 302 can fit over female pipe fitting 602. In this manner, female pipe fitting 602 and male pipe fitting 604 cannot separate as long as unitary lock band 300 remains in place and operational. Adjustable band 102 can be installed on male pipe fitting 604 after the joint is formed. Alternatively, a non-adjustable band can be installed on male pipe fitting 604 before the joint is formed, and attachment 302 can be welded on the non-adjustable band before or after the joint is formed.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A device comprising:
an adjustable band configured to be installed around a first pipe section adjacent to a pipe joint between the first pipe section and a second pipe section; and
a locking assembly disposed on the adjustable band, the locking assembly configured to secure the pipe joint between the first pipe section and the second pipe section.

2. The device of claim 1 wherein the adjustable band comprises a metal or plastic band.

3. The device of claim 1 wherein the adjustable band comprises a plurality of slots disposed in the adjustable band.

4. The device of claim 1 wherein the adjustable band comprises a locking mechanism configured to allow a circumference of the adjustable band to be adjusted.

5. The device of claim 1 wherein the locking assembly comprises a strap having at least one slot that the adjustable band is threaded through.

6. The device of claim 1 wherein the locking assembly comprises an attachment that is removably attached to the adjustable band and having a clip that is configured to be placed over a female pipe connector.

7. The device of claim 1 wherein the locking assembly comprises an attachment that is welded to the adjustable band and having a clip with a machined protrusion that is configured to be placed over a female pipe connector.

8. The device of claim 1 wherein the adjustable band further comprises:
a first adjustable band configured to be installed on a first pipe of a pipe joint assembly; and
a second adjustable band configured to be installed on a second pipe of the pipe joint assembly.

9. The device of claim 8 wherein the locking assembly comprises a plurality of straps, wherein the first adjustable band is threaded through one end of each of the plurality of straps, and the second adjustable band is threaded through the opposite end of each of the plurality of straps.

10. The device of claim 9 wherein each of the plurality of straps comprises four slots, the first adjustable band is threaded through a first two slots of each strap and the second adjustable band is threaded through a second two slots of each strap.

11. A device comprising:
a band configured to be installed around a first pipe section adjacent to a pipe joint between the first pipe section and a second pipe section; and
a locking assembly clipped onto the band, the locking assembly configured to secure the pipe joint between the first pipe section and the second pipe section.

12. The device of claim 11 wherein the band comprises a metal or plastic band.

13. The device of claim 11 wherein the band comprises a plurality of slots disposed in the adjustable band.

14. The device of claim 11 wherein the band comprises a locking mechanism configured to allow a circumference of the band to be adjusted.

15. The device of claim 11 wherein the locking assembly comprises a strap having at least one slot that the band is threaded through.

16. The device of claim 11 wherein the locking assembly comprises a clip end configured to clip over the band and a hook end configured to hook onto a female pipe fitting.

17. A device comprising:
a band configured to be installed around a first pipe section adjacent to a pipe joint between the first pipe section and a second pipe section; and
an attachment that is welded to the band and having a clip with a machined protrusion that is configured to secure the pipe joint between the first pipe section and the second pipe section.

18. The device of claim 17 wherein the band comprises a metal or plastic band.

19. The device of claim 17 wherein the band comprises a plurality of slots disposed in the adjustable band.

20. The device of claim 17 wherein the protrusion is configured to be placed over a female pipe connector.
